(19) United States
(12) Patent Application Publication
(10) Pub. No.: US 2005/0272451 A1
(43) Pub. Date: Dec. 8, 2005

(54) [METHOD OF REMOTELY MANAGING MOBILE COMMUNICATION DEVICE]

(76) Inventors: David Ho, Taipei (TW); Feng Kuo, Shanghai City (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,894

(22) Filed: Jun. 4, 2004

(51) Int. Cl. H04Q 7/20

(52) U.S. Cl. 455/466; 455/418

(57) ABSTRACT

A method of remotely managing a mobile communication device is provided. At least a short message having an application program is provided. Next, the application program is sent to the mobile communication device and the application program is run on the mobile communication device. The present invention utilizes the short message service to send the program code to the mobile communication device and runs the program on the mobile communication device. Hence, the present invention can achieve the objective of remotely managing the mobile communication device without additional hardware cost. In addition, by using the popular cross-platform program technology (e.g., J2ME), the remote management function can be achieved in different mobile communication device platforms without modifying the program code.

### BACKGROUND OF INVENTION

1. Field of the Invention

This invention generally relates to a mobile communication device, and more particularly to a method of remotely managing a mobile communication device.

2. Description of Related Art

In the modern era, portability and efficiency are very important. Hence, the mobile communication devices are indispensable because of their communication and portability capabilities. Among several mobile communication devices, the mobile phone has become the indispensable tool in our daily life. The short message service (SMS) is one of the most important functions of the mobile phone. The users can send information to each other via the SMS. SMS is a service of the global mobile communication system. SMS allows the user to send the data with a fixed size (about 160 English characters or 80 Chinese characters). Based on the different targets, the SMS includes broadcast SMS and point-to-point SMS. Currently the most common short message is text message or text message with graphic attachment.

Because of its portability, the mobile communication device may cause some management concerns such as tracing the position of the mobile communication device. Taking the mobile phone as an example, it has a compact size and is easy to carry; however, it is also easy to be lost. If the position of the mobile phone can be traced, it would be very helpful to the user to recover the lost mobile phone back. In addition, by tracing the position of the mobile phone carried by lost children or adults, the lost children or adults can be traced and found.

Hence, it is highly desirable to remotely manage the mobile communication device at any time or trace the updated status or the position of the mobile communication device. By using the communication function of the mobile communication device, the objective of remotely managing the mobile communication device can be achieved. Further, it is highly desirable that the implementation of method of remotely managing the mobile communication device do not increase the hardware cost of the mobile communication device.

### SUMMARY OF INVENTION

The present invention is directed to a method of remotely managing a mobile communication device by using the short message service to send the program code to the mobile communication device and running the program on the mobile communication device in order to remote manage the mobile communication device.

According to an embodiment of the present invention, at least a short message is provided. For example, the short message comprises an application program. The application program is sent to the mobile communication device. Thereafter, the application program is run or executed on the mobile communication device.

In an embodiment of the present invention, the application program is enveloped in the short message.

In an embodiment of the present invention, when the application program has a size larger than a capacity of the short message, the application program is divided into a plurality of program code portions, wherein each of the plurality of program code portions having a size smaller or equal to the capacity of the short message in order to be enveloped in the short message.

In an embodiment of the present invention, the step of executing the application program on the mobile communication device includes: receiving the short message; extracting the application program when the short message includes the application program; and initializing an application program interface of the mobile communication device to run the application program. The short message includes an identification index for determining whether the short message includes the application program.

In an embodiment of the present invention, the application program and the application program interface comply with a Java 2 Micro Edition (J2ME) standard.

According to an embodiment of the present invention, the short message service is utilized to send the program code to the mobile communication device and run the program on the mobile communication device. Thus, the present invention can achieve the objective of remotely managing the mobile communication device without additional hardware cost. In addition, by using the popular cross-platform program technology (e.g., J2ME), the remote management function can be achieved in different mobile communication device platforms without modifying the program code.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1A is a flow chart illustrating a method of remotely managing the mobile communication device (the transmitting end) in accordance with an embodiment of the present invention.

FIG. 1B is a flow chart illustrating a method of remotely managing the mobile communication device (the receiving end) in accordance with an embodiment of the present invention.

### DETAILED DESCRIPTION

To facilitate the description of the present invention, the following embodiment of the present invention takes the mobile phone as an example. The SMS is a standard function available in almost all of the mobile phone. However, currently all mobile phones only take the data in the short message as the user's information (generally, a text message). This embodiment utilizes the popular cross platform program technology such as Java 2 Micro Edition (J2ME) to take the data in the short message as the users program (or an application program). I.e., the data in the short message is not merely a text but also may contain one or several J2ME programs.

When the mobile phone receives this type of short message, it can directly run the J2ME program to achieve the method of remotely managing the mobile phone. The scope of remotely managing the mobile phone would depend on the J2ME platform of the mobile phone. I.e., if the J2ME platform of the mobile phone can provide enough application program interfaces (API), the scope of the remote management can be substantially extended. For example, if the J2ME platform of the mobile phone can provide the APIs for GPS and SMS, one can encode a J2ME program to automatically report the position of the mobile phone. When such a J2ME program is sent to the mobile phone and is run on the mobile phone, the mobile phone can obtain its position via the API for the GPS and send the position back via the API for SMS. Hence, it can provide the function to automatically report the position of the mobile phone.

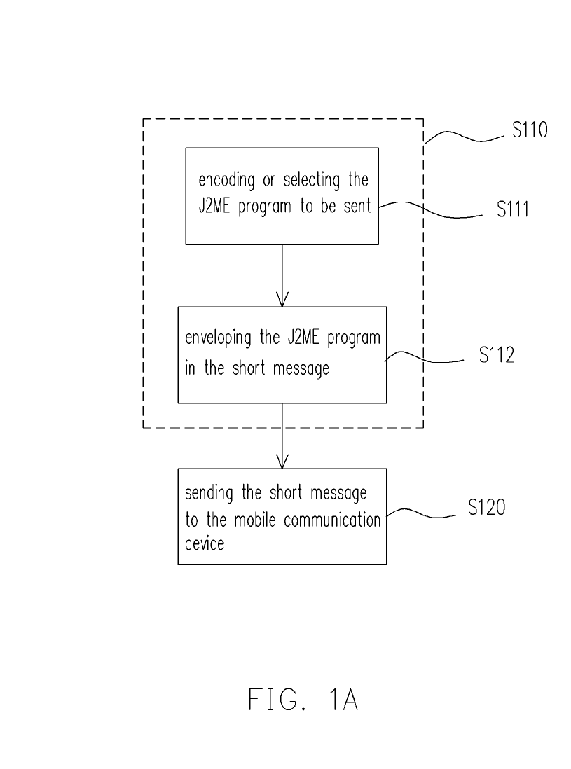

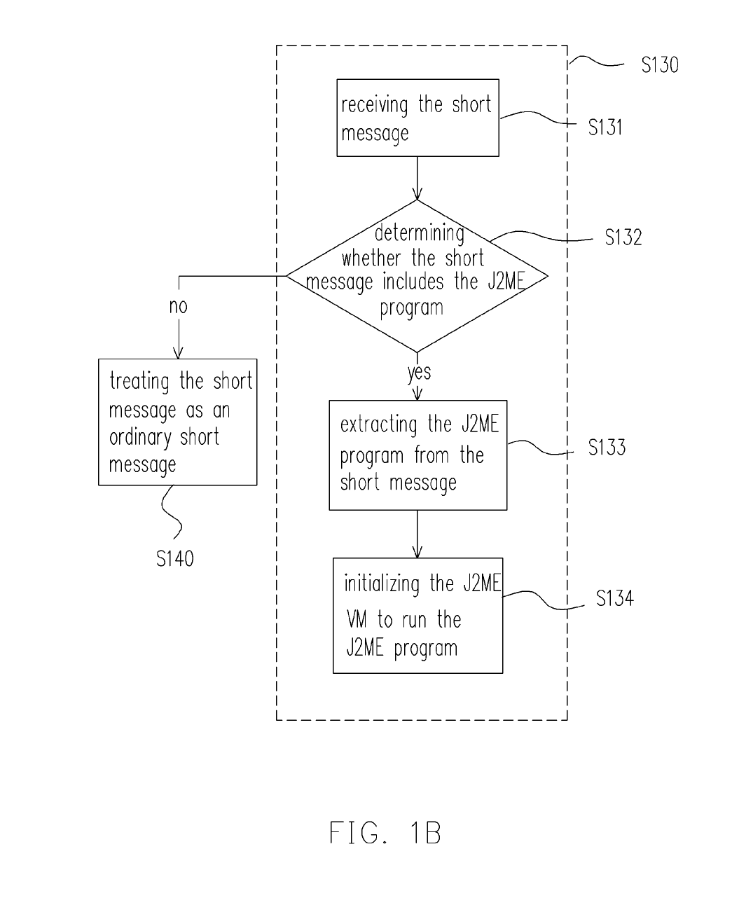

FIG. 1A is a flow chart of a method of remotely managing the mobile communication device (the transmitting end) in accordance with an embodiment of the present invention. FIG. 1B is a flow chart of a method of remotely managing the mobile communication device (the receiving end) in accordance with an embodiment of the present invention. Wherein, the transmitting end means all communications devices suitable for sending short messages (including mobile phone); the receiving end in this embodiment means another mobile phone. Referring to FIGS. 1A and 1B, in step S110, at least a short message is provided. The short message includes an application program. The step S110, according to this embodiment of the present invention, can be implemented by the steps S111 and S112.

In step S111, the application program, i.e., encoded or selected application program to be sent is provided. The above application program in this embodiment, for example, is a J2ME program, which complies with the J2ME standard provided by Sun Microsystems Inc., and can be supported by the receiving end mobile phones using the J2ME platform. Generally, the program developers have to use the J2ME software development kit (SDK) provided by Sun Microsystems Inc., or the mobile phone developers. When selecting the application program to be sent, the user has to make sure that the selected program is supported by the J2ME platform used by the receiving end mobile phone.

In step S112, the application program is enveloped in the short message. Because the short message can attach a self-defined data, the enveloping process divides the J2ME program (when the size of J2ME program is larger than the maximum capacity of the short message) into a plurality of portions and the program portions are filled into the short message structure. This step can be implemented by the websites of the mobile phone developers supporting such a technology or the mobile phones supporting such a technology.

In step S120, the short message is sent to the mobile communication device. In this embodiment, the step of sending the short message with the J2ME program is the same as the step of sending the ordinary short message.

In step S130, the application program is run on the mobile communication device. This embodiment implements the step S130 by the following steps S131, S132, S133, and S134.

In step S131, the short message is received. In this embodiment, the receiving process of the short message is the same as the receiving process of the ordinary short message. But if the J2ME program is divided into several portions, the receiving end has to reassemble all portions of the J2ME program to recover the original J2ME program.

In step S132, whether the short message includes the application program is determined. Because the received short messages are of different types, the receiving end mobile phone has to determine whether the short message includes the application program. To determine whether the short message includes the application program, one approach is to add an identification index such as a text string “J2ME” at the head of the short message; another approach is to initialize the J2ME platform in the receiving end mobile phone in order to determine whether the data is the J2ME program and is supported by the J2ME platform. Both approaches can be used at the same time.

If in the step S132, it is determined that the short message is not a J2ME program, the short message will be treated as the ordinary short message (step S140). Otherwise, the step S133 is performed to extract the application program from the short message. If the J2Me program is extracted in the step S131, then the step 133 can be skipped. Otherwise, the J2ME program will be extracted from the short message in step S131.

In step S134, the application program interface (API) of the mobile communication device is initialized to run the application program. After the J2ME program is extracted from the short message, the receiving end mobile phone can initialize the API to run the J2ME program. In this embodiment, it can initialize the J2ME VM to run the J2ME program. By doing so, the user can take advantage of the cross-platform characteristics, the multimedia supporting ability, and the abundant APIs of the J2ME platform to create the versatile applications.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A method of remotely managing a mobile communication device, comprising:
providing at least a short message, including an application program;
sending said application program to said mobile communication device; and
running said application program on said mobile communication device.

2. The method of claim 1, wherein said step of providing at least said short message includes:
providing said application program; and
enveloping said application program in said short message.

3. The method of claim 2, wherein said step of enveloping said application program in said short message includes: when said application has a size larger than a capacity of said short message, dividing said application program into a plurality of program code portions, each of said plurality of program code portions having a size smaller or equal to said capacity of said short message in order to be enveloped in said short message.

4. The method of claim 1, wherein said step of running said application program on said mobile communication device includes:
receiving said short message;
extracting said application program when said short message includes said application program; and
initializing an application program interface of said mobile communication device to run said application program.

5. The method of claim 4, wherein said short message includes an identification index for determining whether said short message includes said application program.

6. The method of claim 4, wherein said application program and said application program interface comply with a Java 2 Micro Edition (J2ME) standard.

7. The method of claim 4, wherein said application program and said application program interface comply with a predetermined program standard for said mobile communication device.

8. The method of claim 1, wherein there is a plurality of short messages and said step of running said application program on said mobile communication device includes:
receiving said plurality of short messages;
determining whether any one of said plurality of short messages includes a portion of said application program, when few of said plurality of short messages include portions of said application program, extracting said portions of said application program;
reassembling each of said portions of said application program to recover said application program; and
initializing an application program interface of said mobile communication device to run said application program.

9. The method of claim 1, wherein said mobile communication device is a mobile phone.
